(19) United States
(12) Patent Application Publication
(10) Pub. No.: US 2008/0208791 A1
(43) Pub. Date: Aug. 28, 2008

(54) RETRIEVING IMAGES BASED ON AN EXAMPLE IMAGE

(76) Inventors: Madirakshi Das, Rochester, NY (US); Peter O. Stubler, Rochester, NY (US); Alexander C. Loui, Penfield, NY (US); Andrew C. Gallagher, Pittsburgh, PA (US)

Correspondence Address: EASTMAN KODAK COMPANY;PATENT LEGAL STAFF, 343 STATE STREET, ROCHESTER, NY, 14650-2201, US

(21) Appl. No.: 11/679,420

(22) Filed: Feb. 27, 2007

(51) Int. Cl. G06F 17/30

(52) U.S. Cl. 707/1

(57) ABSTRACT

A method is disclosed for retrieving images relevant to an example image from among a plurality of stored images, each of the stored images being associated with metadata of different types, including retrieving set(s) of images from the stored image(s) for each different type of metadata that are based on similarities of the metadata of each different type with the example image; displaying the retrieved set(s) of image(s) organized according to each different type of metadata; and the user selecting one or more particular set(s) of retrieved image(s).

### FIELD OF THE INVENTION

The invention relates generally to the field of digital image processing, and in particular to a method for retrieving stored images based on an example image.

### BACKGROUND OF THE INVENTION

The proliferation of digital cameras and scanners has led to an explosion of digital images, creating large personal image databases. The organization and retrieval of images and videos is already a problem for the typical consumer. Currently, the length of time spanned by a typical consumer's digital image collection is only a few years. The organization and retrieval problem will continue to grow as the length of time spanned by the average digital image and video collection increases, and automated tools for efficient image indexing and retrieval will be required.

Many methods of image classification based on low-level features such as color and texture have been proposed for use in content-based image retrieval. A survey of low-level content-based techniques (“Content-based Image Retrieval at the End of the Early Years”, A. W. M. Smeulders et al. IEEE Transactions on Pattern Analysis and Machine Intelligence, 22(12), Dec 2000) provides a comprehensive listing of relevant methods that can be used for content-based image retrieval. The low-level features commonly described include color, local shape characteristics derived from directional color derivatives and scale space representations, image texture, image transform coefficients such as the cosine transform used in JPEG-coding and properties derived from image segmentation such as shape, contour and geometric invariants. For example, U.S. Pat. No. 6,477,269 B1, issued Nov. 5, 2002 discloses a method that allows users to find similar images based on color or shape by using an example image. U.S. Pat. No. 6,480,840, to Zhu and Mehrotra, issued on Nov. 12, 2002, discloses content-based image retrieval using low-level features such as color, texture and color composition. Though these features can be efficiently computed and matched reliably, they usually have poor correlation with semantic image content.

There have also been attempts to compute semantic-level features from images. In PCT Patent Application WO 01/37131 A2, published on May 25, 2001, visual properties of salient image regions are used to classify images. In addition to numerical measurements of visual properties, neural networks are used to classify some of the regions using semantic terms such as “sky” and “skin”. The region-based characteristics of the images in the collection are indexed to make it easy to find other images matching the characteristics of a given example image. U.S. Pat. No. 6,240,424 B1, issued May 29, 2001, discloses a method for classifying and querying images using primary objects in the image as a clustering center. Images matching a given unclassified image are found by formulating an appropriate query based on the primary objects in the given image. U.S. patent application US 2003/0195883 A1 published on Oct. 16, 2003 computes an image's category from a pre-defined set of possible categories, such as “cityscapes”. A method for automatically grouping images into events and sub-events based on date-time information and color similarity between images is described in U.S. Pat. No. 6,606,411 B1, to Loui and Pavie. U.S. Pat. No. 6,606,398 B2, issued Aug. 12, 2003 to Cooper, describes a method for cataloging images based on recognizing the persons present in the image.

In spite of the availability of these pieces of relevant technology, the problem of enabling meaningful retrieval capabilities for lay users has not been solved. One of the important reasons is the systems inability to infer the user's intentions, given an example image. When the user selects an image or a sub-part of an image to find other images in their collection that match their example, it is not clear what kind of matches the user is looking for, since images can be matched according to a number of orthogonal dimensions. For example, the user can be looking for images of the same person(s) that appear in the example image, or images from the same event or location the example image was taken at, an image with the same color scheme as the example image or a combination of all of the above. Current systems do not have a way to disambiguate the query when given an example image. Some systems have proposed a complex arrangement of slider bars (refer “The QBIC project: Querying images by content using color, texture and shape” by W. Niblack et al. in Proc. of SPIE Storage and Retrieval for Image and Video Databases, pp. 172-187, 1994) to allow the user to emphasize or de-emphasize the search dimensions supported by the system. This approach exposes the technical underpinnings of the system, and makes the system difficult to use for the average user.

A need exists to enable a simple interface to the user to search their collection of images, even when the user has not provided complete search requirements.

### SUMMARY OF THE INVENTION

It is an object of the present invention to provide an effective way of retrieving stored images, which are based on similarities with an example image.

This object is achieved by a method of retrieving images relevant to an example image from among a plurality of stored images, each of the stored images being associated with metadata of different types representing the content of the image, comprising:

(a) retrieving set(s) of stored image(s) for each different type of metadata that are based on similarities of the metadata of each different type with the example image;

(b) displaying the retrieved set(s) of image(s) for each different type of metadata; and

(c) the user selecting one or more particular set(s) of retrieved image(s).

### Advantages

Many image retrieval methods are available based on a variety of different features. However, a simple user query based on an example image is usually ambiguous and current systems do not provide an easy way to provide disambiguation. Most systems either opt for a complicated user interaction to disambiguate a query or provide the user with results that may not be what the user was looking for. In the disclosed method, the ambiguity in an example image used as a query is handled in a meaningful way, providing the user with all the choices and allowing for easy combinations of metadata types.

A method of retrieving images relevant to an example image from among a plurality of images stored in a database is described, each of the stored images being associated with metadata of a various types. An example image is provided by the user in the form of image(s) or sub-image(s). The method comprises of (a) retrieving images from the database that match the example image based on similarity of the metadata of each type (b) providing the user a meaningful grouped presentation of the matches based on each type of metadata.

### BRIEF DESCRIPTION OF THE DRAWINGS

FIG. 1 is a flowchart broadly showing a method in accordance with the present invention;

FIG. 2 depict different set(s) of displayed retrieved images based upon metadata associated with an example image as shown in the method of FIG. 1; and

FIG. 3 depict a way of displaying retrieved images based upon one particular type of metadata.

### DETAILED DESCRIPTION OF THE INVENTION

The present invention can be implemented in computer systems as will be well known to those skilled in the art. The invention has been described in detail with particular reference to certain preferred embodiments thereof, but it will be understood that variations and modifications can be effected within the spirit and scope of the invention.

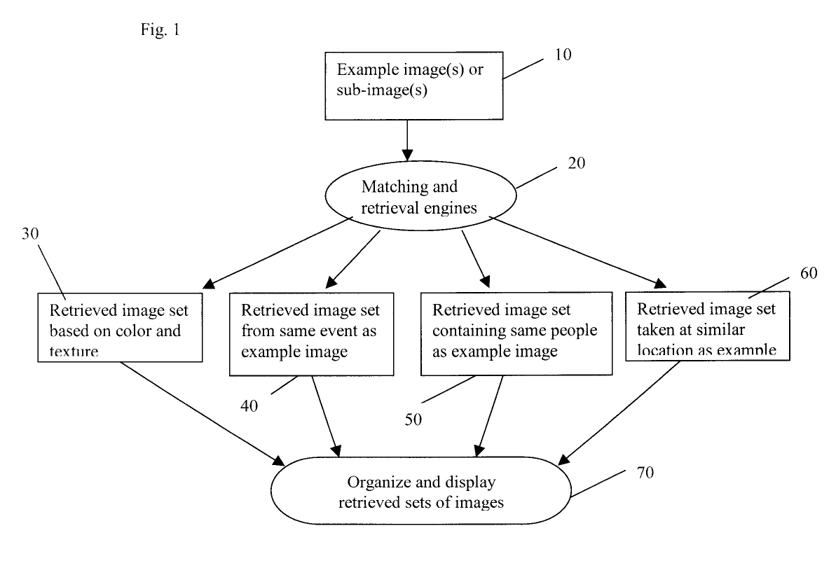

Referring to FIG. 1, the processing starts with an example image as query 10. The example image can be one or more images, sub-images cropped out from images or key-frames from video that are selected by the user from their own collection or acquired from external sources (public web-pages, for example). The example image can be explicitly provided by the user or can simply be the current image being displayed. The example image(s) or sub-image(s) are run through a number of retrieval engines 20 that find similar images in the user's collection. Each retrieval engine uses a different type of metadata for computing similarity. Different types of metadata include capture metadata such as date and time of capture and GPS location, derived low-level metadata such as color and texture of image, derived high-level metadata such as the identified people in images and event, as well as user-centric metadata such as captions or usage information. The number of retrieval engines depends on the availability of technologies for computing and matching metadata. Both the example image and the search collection can include digital images captured in various ways such as by a digital camera, scanners, or created using software.

In accordance with the invention, set(s) of image(s) are retrieved from the stored images for each different type of metadata that are based on similarities of the metadata of each different type with that of the example image. The images in each set are ordered in decreasing order of their similarity with the example image (most similar image first). The retrieved sets of images are organized 70 into groups by the metadata type used in finding similarity.

One set of images is found by comparing low-level color and texture representations 30 (metadata) of the example image with that of the stored images. In one embodiment, color and texture representations are obtained according to commonly-assigned U.S. Pat. No. 6,480,840 by Zhu and Mehrotra issued on Nov. 12, 2002. According to their method, the color feature-based representation of an image is based on the assumption that significantly sized coherently colored regions of an image are perceptually significant. Therefore, colors of significantly sized coherently colored regions are considered to be perceptually significant colors. Therefore, for every input image, its coherent color histogram is first computed, where a coherent color histogram of an image is a function of the number of pixels of a particular color that belong to coherently colored regions. A pixel is considered to belong to a coherently colored region if its color is equal or similar to the colors of a pre-specified minimum number of neighboring pixels. Furthermore, a texture feature-based representation of an image is based on the assumption that each perceptually significant texture is composed of large numbers of repetitions of the same color transition(s). Therefore, by identifying the frequently occurring color transitions and analyzing their textural properties, perceptually significant textures can be extracted and represented. For each agglomerated region (formed by the pixels from all the background regions in a sub-event), a set of dominant colors and textures are generated that describe the region. Dominant colors and textures are those that occupy a significant proportion (according to a defined threshold) of the overall pixels. The similarity of two images is computed as the similarity of their significant color and texture features as defined in U.S. Pat. No. 6,480,840, and only images with similarity above a threshold are retrieved.

A method for automatically grouping images into events and sub-events based on date-time information and color similarity between images is described in commonly-assigned U.S. Pat. No. 6,606,411 B1, to Loui and Pavie. The event-clustering algorithm uses capture date-time information for determining events. Block-level color histogram similarity is used to determine sub-events. The set of images 40 belonging to the same event as the example image are retrieved from the stored images.

There are a number of known face detection algorithms that can be used for the purpose of locating human faces in digital images. In one embodiment, the face detector described in “Probabilistic Modeling of Local Appearance and Spatial Relationships for Object Recognition”, H. Schneiderman and T. Kanade, Proc. CVPR1998, pp. 45-51 is used. This detector implements a Bayesian classifier that performs maximum a posterior (MAP) classification using a stored probability distribution that approximates the conditional probability of face given image pixel data. People detected in images can be recognized as one of the usually small number of individuals that occur in a user's image collection by using face recognition technology such as that available from Identix, Inc. Given an example image, the system retrieves a set of images 50 from the stored images that contain the same person(s) as those present in the example image.

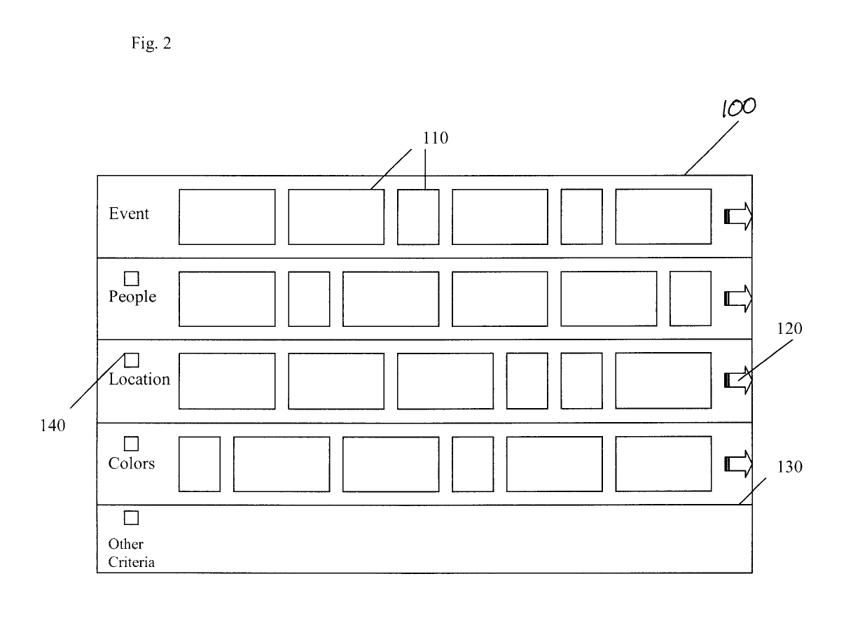

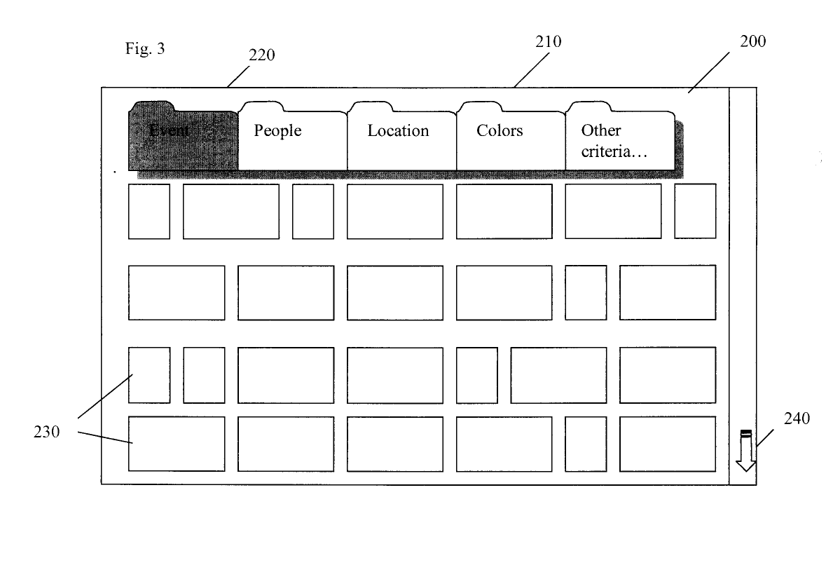

The location the image was captured can be determined from the GPS reading associated with the capture metadata (if available) or can be provided by the user. A set of images captured at a similar location as the example image 60 can be retrieved from the stored images. Similar location can be defined as locations within a certain distance of the location of the example image. A few of the potential dimensions that can be used for comparing images has been enumerated here, but it will be understood that additional search dimensions can be added to this list of metadata types and still be within the spirit and scope of the invention. The retrieved sets of images from the different similarity dimensions are fed to a display mechanism where they are presented as separate groupings, each with a unifying theme. For example, the groupings could indicate similar or same “event”, “people”, “colors” or “place” with respect to the example image. FIG. 2 and FIG. 3 show two possible grouped display mechanisms.

In FIG. 2, the search results (the retrieved sets of images) are displayed in a window 100 using image thumbnails 110. The window 100 is divided into sections using dividers 120. Each section shows images in decreasing order of similarity in terms of the metadata type shown on the left of the section (e.g. “event”). There are scroll arrows 130 to allow the user to view all the images in the section.

In FIG. 3, the top of the search display window 200 has a set of tabs 210 showing each metadata type at the top. Tabs get highlighted 220 when the user selects the tab, and image thumbnails 230 belonging to the search results are displayed in the remaining area of the window. There is a scroll bar to allow the user to view all images.

The user can easily combine two or more metadata types by clicking the checkboxes 140 in FIG. 1 or selecting multiple tabs (by using the common method of holding down the shift or control button while clicking) in FIG. 2. If more than one metadata type is selected the display shows only the image thumbnails that are common to the retrieved sets of all the selected metadata types (performing the join operation in database terminology). This provides the user with an easy way to refine their search by combining different types of metadata. The typical functions of retrieving the larger image when thumbnails are double-clicked and allowing multiple selections from the thumbnail display are also assumed to be supported in this interface.

Two display mechanisms for showing sets of images have been described here, but it will be understood that additional display mechanisms that show sets of images allowing a user to combine the sets are also within the spirit and scope of the invention.

It should be noted that FIGS. 1-3 shows some of the search dimensions based on different metadata types. However, the invention includes other search dimensions for which search technology becomes available. These can be added as parallel processing paths in FIG. 1 that produce their respective search results. In FIG. 2 and FIG. 3, additional search results rows or search tabs can be added to accommodate these other search dimensions. For example, a possible metadata to search on can be scene type. Scene type describes the image content in terms of the objects present in the scene e.g. field, beach, mountain, sunset etc. In “Learning multi-label scene classification” (Pattern Recognition, Vol. 37, 2004), M. Boutell et al. escribes methods to automatically determine the scene type, including images containing more than one scene type. Using this technology in our application, a search on an example image can retrieve other media that have the same scene type as the example; and scene type can appear as one of the tabs/rows in the displayed search results.

The present invention provides an effective yet simple way to retrieve image sets from stored images by organizing them in accordance with metadata and the content of an example image. Image sets that are similar in various meaningful metadata dimensions are retrieved from the stored images. In addition, the search dimensions can be combined by the user to disambiguate the query as needed to provide results relevant to the user's example image.

### PARTS LIST

10 query
20 matching and retrieval engines
50 retrieved image set
60 retrieved image set
70 organize and display retrieved set of images
100 window
110 image thumb nails
120 dividers
130 scroll arrows
140 check boxes
200 display window
210 tabs
220 tabs are highlighted
230 image thumbnails

1. A method of retrieving images relevant to an example image from among a plurality of stored images, each of the stored images being associated with metadata of different types, comprising:
(a) retrieving set(s) of images from the stored image(s) for each different type of metadata that are based on similarities of the metadata of each different type with the example image;
(b) displaying the retrieved set(s) of image(s) organized according to each different type of metadata; and
(c) the user selecting one or more particular set(s) of retrieved image(s).

2. The method of claim 1 wherein step (c) includes the user viewing the images of the selected particular set(s) to further select image(s) for subsequent use.

3. The method of claim 1 wherein the particular type(s) of metadata include: event, people, location, colors, textures or scene types.

4. The method of claim 1 wherein the images are stored in a database having image files and associated metadata.

5. The method of claim 1 wherein the stored images are originated from websites on the internet or digital capture devices or combinations thereof.

6. The method of claim 1 further including computing the different types of metadata from the example image.
